(19) United States
(12) Patent Application Publication
(10) Pub. No.: US 2026/0235723 A1
(43) Pub. Date: Aug. 13, 2026

(54) SYSTEM AND METHOD FOR ANGULAR DECEPTION OF DETECTION SYSTEM

(71) Applicant: Ramot at Tel-Aviv University Ltd., Tel-Aviv (IL)

(72) Inventors: Vitali KOZLOV, Tel-Aviv (IL); Dmytro VOVCHUK, Tel-Aviv (IL); Pavel GINZBURG, Tel-Aviv (IL)

(73) Assignee: Ramot at Tel-Aviv University Ltd., Tel-Aviv (IL)

(21) Appl. No.: 19/156,919

(22) PCT Filed: Feb. 15, 2024
(86) PCT No.: PCT/IL2024/050181

§ 371 Date: Aug. 15, 2025

(30) Foreign Application Priority Data
Feb. 15, 2023 (IL) 300759

(51) Int. Cl. G01S 7/38; G01S 13/75; H01Q 15/00; H01Q 21/00; H01Q 21/28

(52) U.S. Cl. CPC G01S 7/38; G01S 13/753; G01S 13/755; H01Q 15/0066; H01Q 21/0018; H01Q 21/28

(57) ABSTRACT

A system for angular deception, comprises: a structure having a plurality of resonators characterized by a controllable phase shift between an electromagnetic wave incident on the structure and an electromagnetic wave scattered off the structure, and a controller configured for modulating the phase shift at a modulation frequency of at least 0.01 of a bandwidth of the incident electromagnetic wave.

### RELATED APPLICATIONS

This application claims the benefit of priority of Israeli Application No. 300759 filed on Feb. 15, 2023, the contents of which are incorporated herein by reference in their entirety.

### FIELD AND BACKGROUND OF THE INVENTION

The present invention, in some embodiments thereof, relates to and deception of a detection system and, more particularly, but not exclusively, to system and method for angular deception of detection system.

The invention of radars was soon followed by extensive research and development of counter measures. By employing special geometric designs and carefully selected materials, a reduction of the target's radar cross section and the resulting backscattered energy was successfully achieved, substantially reducing distances between the radar and the target for successful detection. In addition to stealth technology, numerous active jamming countermeasures have been developed. In this case, signals are transmitted to the investigating radar systems, either to cause the radar to wrongly conclude estimation parameters, or to blind the radar by degrading the signal to nose ratio.

The traditional active jamming strategy relies on transmitting noise toward the radar to reduce its signal-to-noise ratio (SNR), diminishing the minimal range of detection at the expense of radio silence. Spoofing methods keep developing to supplement active jamming, with chaff decoys being the simplest example, designed to create false “ghost” targets on the screen of the investigating radar [21]-[26]. More advanced spoofing methods introduce repeaters that control the signatures on the reflected echoes, delaying them in time and imprinting false Doppler shifts which cause the radar to deduce the wrong trajectory and location of targets [27]-[30].

Recently metamaterials and metasurfaces had been the focus of concentrated efforts to shape scattered waves [34]-[39] in order to cloak objects of interest from investigation.

### SUMMARY OF THE INVENTION

According to an aspect of some embodiments of the invention there is provided a system for angular deception. The system comprises: a structure having a plurality of resonators characterized by a controllable phase shift between an electromagnetic wave incident on the structure and an electromagnetic wave scattered off the structure; and a controller configured for modulating the phase shift at a modulation frequency of at least 0.01 of a bandwidth of the incident electromagnetic wave.

According to some embodiments of the invention the structure comprises a receiving element receiving the incident electromagnetic wave, a transmitting element transmitting the scattered electromagnetic wave, and phase delay circuit between the receiving and the transmitting elements.

According to some embodiments of the invention the phase delay circuit is configured to ensure a time-dependent phase delay between the incident electromagnetic wave and the scattered electromagnetic wave.

According to some embodiments of the invention at least one of the phase delay circuits comprises an electronic element having a controllable impedance, wherein the controlling the phase shift comprises varying the impedance.

According to some embodiments of the invention the electronic element has a voltage-dependent impedance, and wherein the varying the impedance comprises varying a bias voltage applied to the electronic element.

According to some embodiments of the invention the system comprises a metal screen and dielectric structure, between the resonators and the metal screen, wherein the resonators are mounted on the dielectric structure.

According to some embodiments of the invention the modulation comprises harmonic modulation.

According to some embodiments of the invention the modulation frequency is from about 10 MHz to about 50 GHz.

According to some embodiments of the invention at least a portion of the resonators are also characterized by a controllable resonance frequency, and wherein the controller is configured for controlling the resonance frequency to provide a time-varying resonance frequency characterized by a temporal function which comprises a linear time-dependence.

According to some embodiments of the invention the controller is configured to receive velocity data characterizing a motion of a vehicle and to select the time-varying resonance frequency based on the velocity data.

According to some embodiments of the invention the phase shift is over a respective range of at least 1.5π.

According to some embodiments of the invention the system is configured for a central frequency of the incident wave, wherein at least one of the resonators has a dispersive response to the incident wave, the dispersive response being selected to ensure that the phase shift range is effective for any frequency within a frequency band of at least 10% of the central frequency.

According to some embodiments of the invention the dispersive response comprises a frequency-dependent impedance.

According to some embodiments of the invention at least one of the resonators is configured to maintain, within a predetermined tolerance, equality between a frequency of the scattered wave and a frequency of the incident wave.

According to some embodiments of the invention at least one of the resonators comprises an electronic element having a controllable impedance, wherein the controlling the resonance frequency comprises varying the impedance.

According to an aspect of some embodiments of the invention there is provided a vehicle. The vehicle comprises a propulsion system carried by a vehicle body, and the system as delineated above and optionally and preferably as further detailed below.

According to some embodiments of the vehicle is a manned vehicle.

According to some embodiments of the vehicle is an unmanned vehicle.

According to some embodiments of the vehicle is a controllable vehicle.

According to some embodiments of the vehicle is an autonomous vehicle.

According to an aspect of some embodiments of the present invention there is provided a method of angular deception of a detection system transmitting an electromagnetic wave, the method comprising: scattering the detection system's wave off a structure having a plurality of resonators characterized by a controllable phase shift between an electromagnetic wave incident on the structure and an electromagnetic wave scattered off the structure; and modulating the phase shift at a modulation frequency of at least 0.01 of a bandwidth of the incident electromagnetic wave.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are schematic illustrations showing angular deception according to some embodiments of the present invention. FIG. 1A illustrates detection by an investigating radar of object without a metasurface cover. FIG. 1B illustrates a situation in which the object is provided with a metasurface cover, wherein a dynamic control of the scattering properties of the metasurface conceals the angular location of the object from the investigating radar.

FIGS. 2A and 2B are schematic illustrations showing direction of arrival deception by time-modulated scatterers. FIG. 2A illustrates an array of receivers observing a object without a metasurface cover. In this case the object reflects a plane wave towards the radar. FIG. 2B illustrates a situation in which the object is provided with a metasurface cover, which is time-modulated. In this case the modulation controls the phase of the plane wave in a manner that breaks the coherence between the phases of the receiving antennas, thereby concealing the angular location of the object. In FIG. 2B, dashed lines show wavefronts that would have been existed in the absence of time-modulation, and solid lines show wavefronts modified by the time-modulation.

FIG. 3 shows an image of an experimental setup used in experiments performed according to some embodiments of the present invention. The experiments were performed in an anechoic chamber. A CW radar interrogated a time-modulated scatterer via a transmitting log-periodic antenna (designated Tx Antenna in FIG. 3) while receiving with a 4-element uniform antenna array (designated Rx Antenna Array in FIG. 3). The schematic inset of FIG. 3 illustrates an equivalent electronic circuit of the time-modulated scatterer, including a delay line, a bias-controlled phase shifter, and an amplifier, allowing for dynamic arbitrary reflected phase control.

FIG. 4 shows control over the perceived direction of arrival of a object provided with a time-modulated metasurface cover, as obtained in experiments performed according to some embodiments of the present invention. By controlling the modulation frequency of the reflected phase from the object, it may appear to the radar in a different direction than it truly is, with increasing modulation frequency and true angular location increasing the error. Insets zoom in on two regions of the graph. Lines show theoretical calculations for various values of Ω and circles show corresponding experimental results obtained using the setup shown in FIG. 3.

FIG. 5 is a schematic illustration of a deception system, according to some embodiments of the present invention.

FIG. 6 is a schematic illustration of a deception system, according to embodiments of the present invention in which the system provides both angular and motion deception.

FIG. 7A is a schematic illustration of a system suitable for providing motion deception, according to some embodiments of the present invention.

FIG. 7B is a schematic illustration of an equivalent circuit describing electronic properties of an electronic element of the system shown in FIG. 7A, according to some embodiments of the present invention.

FIG. 8 is a flowchart diagram describing a method suitable for deception a detection system, according to some embodiments of the present invention.

FIG. 9 is a schematic illustration of a vehicle, according to some embodiments of the present invention.

### DESCRIPTION OF SPECIFIC EMBODIMENTS OF THE INVENTION

The present invention, in some embodiments thereof, relates to and deception of a detection system and, more particularly, but not exclusively, to system and method for angular deception of detection system.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

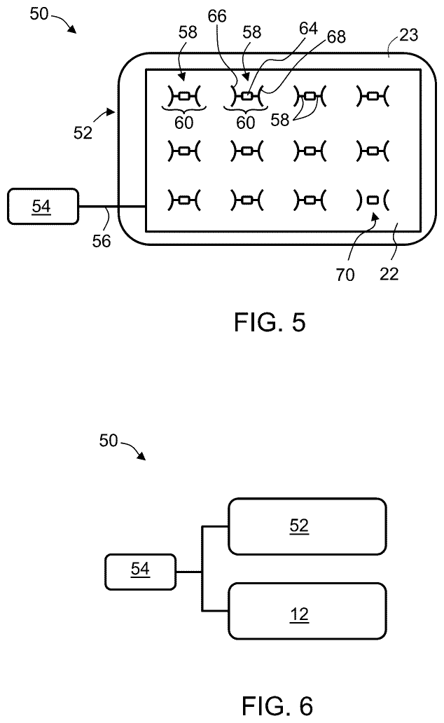

Referring now to the drawings, FIG. 5 is a schematic illustration of a system 50 for angular deception, according to some embodiments of the present invention. The detection system can be any detection system. Preferably, the detection system contains a direction of arrival (DOA) functionality, such as, but not limited to, detection system having an array of receiving antennas, and being configured to identify phase differences between waves received at different antennas of the array. In some embodiments of the present invention the detection system is a radar having a phased array antenna.

System 50 comprises a structure 52 configure to generate a controllable phase shift between a wave incident on structure 52 and a wave scattered off structure 52. The wave is typically an electromagnetic wave transmitted by a detection system (not shown) so as to interrogate an object (e.g., vehicle) carrying system 50. Preferably, but not necessarily, the scattered wave has at a frequency of from about 1 KHz to about 100 GHz. Structure 52 can be in any known form that can generate such a phase shift in controllable manner. Representative examples include, without limitation, a metamaterial a metasurface, a time-dependent mask and the like. In some embodiments of the present invention structure 52 is provided as a plurality of resonators 60, each being configured to actively control the phase shift between the wave incident on the respective resonator and the part of the wave scattered off the respective resonator.

Structure 52 is typically a synthetic cellular structure.

As used herein, “cellular” is used to indicate that the structure defines a network of generally repeating and inter-coupled cells 58. The coupling between the cells 58 is preferably near field coupling. In some embodiments of the present invention each cell comprises one of the resonators 60.

As used herein “near field coupling” refers to interaction by exchanging a non-radiative physical field (e.g., electric field, magnetic field, electromagnetic field).

Preferably, but not necessarily, the resonators 60 of structure 52 are arranged as an array. The array shown in FIG. 5 is defined over a rectangular grid, but this not necessarily be the case, since, for some applications, it may be desired to define a non-rectangular grid (e.g., triangular, hexagonal, etc).

System 50 further comprises a controller 54, having a circuit configured for activating the structure 52. Controller 54 and structure 52 typically communicate via one or more communication lines 56, which can be wired, as illustrated, or wireless.

Each of the resonators 60 can comprise a circuit 64 that is configured to generates the aforementioned controllable phase shift. In various exemplary embodiments of the invention the circuits 64 are controllable by the circuit of controller 54. Controller 54 can control each of the resonator circuits 64 individually, or it can be configured to control one or more (e.g., all) the resonator circuits 64 collectively. When two or more resonator circuits are controlled individually, the controller can set different phase shifts to different individually-controlled circuits. When two or more resonator circuits are controlled collectively, the controller can apply the same phase shift for all the collectively-controlled circuits.

Resonators 60 are typically mounted (e.g., soldered, glued, printed, or otherwise connected) on a dielectric structure 22, serving for supporting the array. Dielectric structure 22, is optionally and preferably conformal to the surface of the object to be concealed from the detection system.

In use, the side of dielectric structure 22 which is opposite to the resonator array is mounted on an external surface of an object to be concealed from the detection system, thereby also serving as a spacer between the surface of the object and the resonators. The thickness of dielectric structure 22 is typically several millimeters but other thicknesses are also contemplated. Dielectric structure 22 is optionally and preferably made of a material that is transparent to the wave for which system 50 is designed, which is typically the frequency band of the electromagnetic radiation which is expected to be transmitted by the detection system. The dielectric losses can degrade the resonant behaviors of the structure 52, but can be compensated by additional elements. In some embodiments of the present invention a metal screen 23 can be introduced between the surface of the object to be concealed and the structure 52 to uncouple electromagnetic properties of the object's surface from structure 52. The thickness of screen 23 is optionally and preferably several skin depths of the incident wave.

In some embodiments of the present invention the circuit of controller 54 is configured for modulating the phase shifts generated by of resonators 60 to provide a time-dependent phase delay between the incident wave and the scattered wave. The modulation is optionally and preferably characterized by a modulation frequency of at least 0.01 or at least 0.05 or at least 0.1 of the bandwidth of the incident wave. Preferably, the controller ensures that the phase delay variation is characterized by a temporal function which comprises a harmonic time-dependence, more preferably a temporal function which is dominated by a harmonic time-dependence, more preferably a harmonic temporal function.

A temporal function is said to be dominated by a harmonic time-dependence, if a ratio between the non-harmonic part and harmonic parts of the temporal function is less than 10% for any time during the variation applied by the controller.

The controllability of the phase shift generated by resonator 60 is ensured by a judicious selection of circuit 64. For example, circuit 64 can be a phase delay circuit, configured for introducing a controlled phase shift to a signal passing through it. The present embodiments contemplates any type of circuit that can introduce a phase delay to a signal. Representative examples include, without limitation, a circuit comprising a resistor and capacitor, wherein at least one of the resistor and the capacitor has electrical characteristics (e.g., resistance, impedance, capacitance) that is/are controllable by controller 54, a circuit comprising an inductor and a capacitor wherein at least one of the inductor and the capacitor has controllable electrical characteristics (e.g., inductance, impedance, capacitance) that is/are controllable by controller 54, a circuit employing digital signal processing techniques to introduce phase shifts wherein at least part of the digital processing that is controllable by controller 54, and the like. The control over any of the above types of phase delay circuits is preferably an electrical control. For example, the phase delay applied by a particular circuit can be selected by selecting a voltage applied to the respective circuit.

Resonator 60 typically also comprises a receiving element 66 receiving the incident wave, a transmitting element 68 transmitting the scattered, wherein the circuit 64 is between the receiving 66 and transmitting 68 elements. The circuit 64 can be connected by conductor 58 to elements 66 and 68, as illustrated in FIG. 5. Alternatively, the resonator 60 can have an air gap 70 and circuit 64 can be at the air gap. For clarity of presentation, only one of the resonators in system 50 is illustrated as having an air gap, but the present embodiments contemplate configurations in which all resonators have an air gap, configurations in which no resonator has an air gap, and configurations in which some of the resonators have an air gap and some of the resonators do not have an air gap.

In some embodiments of the present invention elements 66 and 68 can be arranged to form an electric diploe. Also contemplated are embodiments in which elements 66 and 68 are arranged to form a magnetic dipole.

The present embodiments also contemplate embodiments in which system 50 is configured to cloak a detection system which contains a moving target indicator (MTI) based on phase information. In some embodiments of the present invention the detection system is a radar. In these embodiments, system 50 can comprise two structures. A first structure is configured to generate a controllable phase shift between the incident wave and the scattered wave, and a second structure has a controllable resonance frequency. The first structure can be structure 52 as further detailed hereinabove with reference to FIG. 5. The second structure can be similar to the structure described in international patent application, publication No. WO2021/210004, the contents of which are hereby incorporated by reference.

A schematic illustration of this configuration of system 50 is illustrated in FIG. 6, showing structure 52 which controls the phase shift, and structure 12 which has a controllable resonance frequency. Both structures 52 and 12 can be controlled by the same controller 54. Alternatively, structures 52 and 12 can be controlled by separate controller, e.g., independently. Structure 52 and 12 can be arranged laterally, as illustrated in FIG. 6, or they can be arranged one on top of the other. Also contemplated, are embodiments in which both structure 52 and 12 are provided as a single structure. For example, when structures 52 and 12 comprise arrays of resonators, or arrays of individual cells, the arrays can be laterally interlaced with each other.

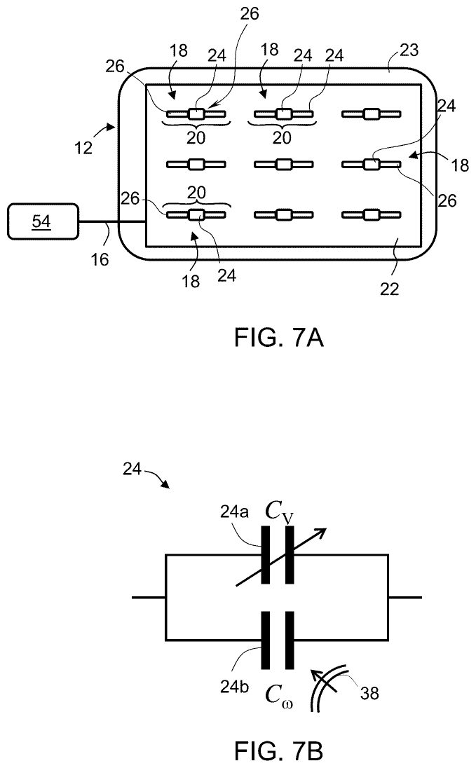

FIG. 7A illustrates structure 12 in greater detail. Structure 12 has a controllable resonance frequency, and is controller by a controller, e.g., controller 54. Controller 54 and structure 12 typically communicate via one or more communication lines 16, which can be wired, as illustrated, or wireless.

Structure 12 is a synthetic cellular structure defining a network of generally repeating and inter-coupled cells 18 arranged as an array, wherein the coupling between the cells 18 is preferably near field coupling. Structure 12 scatters a wave interacting therewith. The wave is typically an electromagnetic wave as further detailed hereinabove. Structure 12 can be in any known form that has controllable resonance frequency. Representative examples including, without limitation, a metamaterial a metasurface, a time-dependent mask and the like.

Each of the cells 18 optionally and preferably comprises a resonator 20, which is a circuit that is configured to electromagnetically resonate at a frequency referred to as a resonance frequency. In various exemplary embodiments of the invention the resonance frequency of the resonator 20 is controllable, and the circuit of controller 14 is configured to control this frequency as further detailed below. Controller 14 can control each of the resonator circuits individually, or it can be configured to control one or more (e.g., all) the resonator circuits collectively. When two or more resonator circuits are controlled individually, the controller can set different resonance frequencies to different individually-controlled circuits. When two or more resonator circuits are controlled collectively, the controller can apply the same change to the resonance frequencies of all the collectively-controlled circuits (e.g., the controller can set the same resonance frequencies to the collectively-controlled circuits). Adjustable control over resonant frequencies can optionally and preferably also provide a countermeasure against frequency hopping interrogating systems.

Resonators 20 are typically mounted on dielectric structure 22, as further detailed hereinabove. In some embodiments of the present invention metal screen 23 is introduced between the surface of the object to be concealed and the structure 12 as further detailed hereinabove.

In some embodiments of the present invention the circuit of controller 54 is configured for controlling the resonance frequency of resonators 20 to provide a time-varying resonance frequency. Preferably, the controller ensures that the resonance frequency variation is characterized by a temporal function which comprises a linear time-dependence, more preferably a temporal function which is dominated by a linear time-dependence, more preferably a linear temporal function. In some embodiments of the present invention the entire resonance of the structure 12 can be shifted to a desired frequency to cope with, for example, frequency hopping radars.

A temporal function is said to be dominated by a linear time-dependence, if a ratio between the nonlinear part and linear parts of the temporal function is less than 10% for any time during the variation applied by the controller.

Preferably, the linear time-dependence is linear modulo 2π. Mathematically, a time-dependence which is linear modulo 2π can be written as f(t)=a+b t (mod 2π), where f is an observable (e.g., resonance frequency) which varies according to the time dependence, a is a constant offset parameter, b is a constant slope parameter, t is the time variable of the time-dependence, and mod is a function which returns the modulus of the operation, which in this case is the remainder of the division of t by 2π.

The inventors found that sleeting a temporal function which comprises a linear time-dependence, is advantageous for cloaking, in particular when the incident wave is transmitted by a detection system employing a moving target indicator (MTI) filter, as explained in international patent application, publication No. WO2021/210004, supra.

In some embodiments of the present invention the circuit of controller 54 receives velocity data characterizing the motion of the vehicle on which structure 12 is mounted and selects the time-varying resonance frequency based on the velocity data. For example, controller 54 can derive from the velocity data a linear time-dependence characterized by a slope parameter that is linearly proportional to the velocity of the vehicle, and vary the resonance frequency according to the derived time-dependence, preferably modulo 2π, thus compensating for the Doppler phase shift due to this velocity. The controller can also include a detection of arrival (DoA) detector to define the interrogation direction. The time-variation optionally and preferably compensates the radial velocity in respect to the antenna of the detection system. Angular reflectivity of the device can also be adjusted accordingly.

In some embodiments of the present invention the circuit of controller 54 is configured to not significantly modulate the frequency of the wave transmitted by the detection system. In other words, in these embodiments the circuit of controller 54 maintains, within a predetermined tolerance (e.g, ±20%, or ±10%, or ±5%), equality between the frequency of wave scattered off structure 12 and the frequency of the wave transmitted by the detection system.

The resonators 20 of structure 12 are preferably arranged to collectively ensure that when the resonance frequency is varied over a predetermined range of resonance frequencies, the resulted phase shift between the wave incident on structure 12 and the wave scattered off structure 12, is over a respective range of at least 1.5π, more preferably at least 1.8π, more preferably at least 1.9π, e.g., about 2π or more. Specifically, characterizing the predetermined range of resonance frequencies by a lower frequency threshold f_{L} and an upper frequency threshold f_{U}, and the resonators 20 are preferably arranged to collectively ensure that there is a one-to-one mapping between the range [f_{L},f_{U}] and the phase shift range [0,φ_{MAX}], where φ_{MAX} is at least 1.8π, more preferably at least 1.9π, most preferable about 2π or more. For example, a resonance frequency of f_{L} can be mapped to a zero phase shift, a resonance frequency of f_{U} can be mapped to a phase shift of φ_{MAX}, and any resonance frequency f satisfying f_{L}<f<f_{U} can be mapped to a unique phase shift φ satisfying 0<φ<φ_{MAX}.

The controllability of the resonance frequency of resonator 20 can in some embodiments of the present invention be achieved by providing each resonator with an electronic element 24 having a controllable capacitance or any other resonant shifting element, such as, but not limited to, an inductor. In this case controller 54 controls the resonance frequency of the resonator by varying the impedance (e.g., capacitance) of element 24. For example, electronic element 24 can have a voltage-dependent impedance, and controller 54 can control the resonance frequency by varying the voltage applied to the electronic element. A representative example of an electronic element with a voltage-dependent impedance, and which is suitable for the present embodiment is a varactor. The dependence of the impedance on the voltage need not to be linear. For example, in varactors the impedance typically varies nonlinearly with the applied bias voltage. When the dependence of the impedance on the voltage is nonlinear, controller 54 preferably varies the voltage nonlinearly with the time according to a nonlinear time-dependence selected to at least partially cancel the nonlinearities of the voltage-dependence of the impedance.

Resonator 20 typically also comprises an antenna 26 that interacts with the incident wave and resonate responsively to this interaction. In the schematic illustration of FIG. 7A, which is not to be considered as limiting, the antenna 26 is a dipole antenna defining an airgap 28, wherein electronic element 24 is at the airgap 28. It is to be understood that other shapes for the antenna 26 are also contemplated.

While the embodiments below are described with a particular emphasis to electric dipoles, it is to be understood that the present embodiments also contemplate use of magnetic dipoles instead of, or in addition to, electric dipoles.

In some embodiments of the present invention one or more of resonators 20 has a dispersive response to the incident wave. This is advantageous since the dispersive response of resonator 20 can be selected to increase the bandwidth over which the aforementioned one-to-one mapping between the range of resonance frequencies and the phase shift range is effective. Preferably, the dispersive response is selected such that the phase shift range is effective for any frequency within a frequency band of at least 10% or at least 15% or at least 20% or of the central frequency of the incident wave.

A dispersive response of resonator 20 can be achieved by constructing the electronic element 24 as a dispersive element. For example, the dispersive response can be a dispersive impedance (e.g., capacitance), in which case electronic element 24 can be constructed to exhibit a dispersive impedance property, e.g., a frequency-dependent impedance. When the controllability of electronic element 24 is embodied as a voltage-dependent impedance, the dispersive impedance of electronic element 24 can be achieved by combining two or more frequency responsive elements (e.g., capacitive elements, inductive elements), where at least one of these capacitive elements has a voltage-dependent impedance and at least one these frequency responsive elements has a frequency-dependent impedance, thereby providing an electronic element in which the impedance varies both with the voltage and with the frequency. The use of dispersive element is advantageous since it increases the operation bandwidth. However, the inventors found that the system of the present embodiments is useful against many detection systems even without dispersive elements, wherein element 24 is a nondispersive element. A schematic illustration of an equivalent circuit describing the electronic property of electronic element 24 suitable for these embodiments is provided in FIG. 7B. Shown in FIG. 7B are a controllable voltage-dependent capacitor 24a (e.g., a varactor) and a frequency-dependent capacitor 24b, connected in parallel to each other so that the effective capacitance C of element 24 is C=C_{V}+C_{w}, where C_{V} is the capacitance of capacitor 24a and C_{w} is the capacitance of capacitor 24b. While FIG. 7B illustrators to additional elements in the equivalent circuit, it is to be understood that the equivalent circuit may include additional or other elements, provided these elements aid in tuning the resonance frequency of the cells 18.

In various exemplary embodiments of the invention the frequency-dependent capacitor 24b is not controlled by controller 74, so that any variation in the capacitance C_{ω} of capacitor 24b is in response to the incident wave. In some embodiments of the present invention the associated reactance of the frequency-dependent capacitance C_{ω} of capacitor 24b is a decreasing function of the frequency. It is to be understood that capacitor 24b need not be a capacitor per se, and that active electronic circuitry can be designed to enact capacitor 24b.

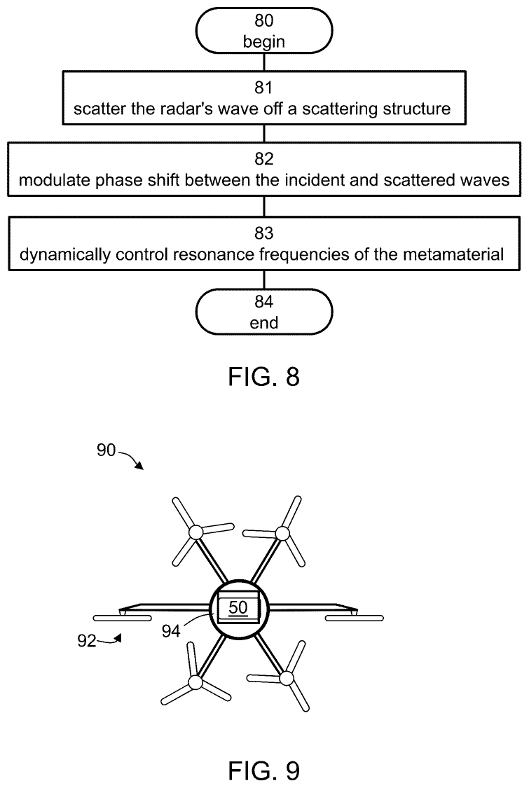

Reference is now made to FIG. 8, which is a flowchart diagram describing a method suitable for deception a detection system transmitting an electromagnetic wave, according to some embodiments of the present invention. Selected operations of the method can be executed using system 50.

The method begins at 80 and optionally and preferably continues to 81 at which the detection system's wave is scattered off a scattering structure, such as, but not limited to, structure 82, and/or structure 12. The method continues to 82 at the phase shift between the incident wave and the scattered wave is modulated, as further detailed hereinabove. In some embodiments of the present invention the method proceeds to 83 at which the resonance frequencies of the structure are dynamically control to provide a time-varying resonance frequency characterized by a temporal function which comprises a linear time-dependence, as further detailed hereinabove. In some embodiments of the present invention the temporal function is selected based on received velocity data as further detailed hereinabove.

The method ends at 84.

FIG. 9 is a schematic illustration of a vehicle 90, according to some embodiments of the present invention. Vehicle 90 comprises a propulsion system 92 carried by a vehicle body 94, and system 50 mounted on an external surface of vehicle body 94. System 50 can include one or more of the components and characteristics described above with respect to FIGS. 5, 6, 7A, and 7B. Vehicle 90 can be of any type, including, without limitation, a manned vehicle, an unmanned vehicle, a controllable vehicle, and an autonomous vehicle. In some embodiments of the present invention vehicle is an aerial vehicle, such as, but not limited to, a drone, an airplane, a zeppelin, and the like.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Modern radar systems are capable to detect targets with high accuracy and even classify them remotely. This continuous progress goes hand in hand with developing radar countermeasures, where passive radio-silent solutions start to prevail over active jamming approaches. While the range and Doppler information are typically targeted for deception, conventional systems lack the capability to conceal the angular location of an object. The direction of targets in respect to a radar system can be deduced from the correlation between the sampled phases in the different antennas forming the receiving array. By breaking this coherent relationship, the present embodiments cause the radar to estimate the wrong direction of arrival, deceiving it into concluding the object is elsewhere. This Example presents an exemplified method for achieving this by controlling the reflected phase from a time-modulated scatterer. The following demonstrates suitability for implementation via time-dependent metasurfaces supporting a semi-passive (battery-assisted) mode of operation. This Example demonstrates control over the perceived angular location of the concealed target, with proven ability to steer the direction of arrival on demand by over 5 degrees away from its true angular position. This new type of electronic countermeasure works better with increasing radar bandwidth, turning its strength into an exploitable weakness.

Modern radar systems are an integral part of virtually any sensing application [1]-[7] and are expected to continue playing a vital part in fused sensory networks. Their ubiquitous nature stems from their relatively low electromagnetic operational frequency which can penetrate fog, foliage, and other obstructions that complicate observation with optical and sonic devices alike. These advantages had led to the development of hardware and software solutions [8]-[12] that also contributed to radar analogues in the domains of sonar and LIDAR. Yet it was exactly their tremendous success and widespread use that ushered a race for electronic countermeasures (ECM) to evade detection, which soon found themselves the target of counter countermeasures (ECCM) and so on in apparent perpetuity [13]-[18].

Stealth technologies emerged with the aim of minimizing the signatures of targets [19], [20], providing a passive solution to avoiding detection. But even for very absorbent materials and carefully crafted geometries, the standoff distance could only be reduced so much, with multi-static radars still posing a considerable challenge. To overcome these issues and to provide solutions in cases where radar scattering suppression strategies are not applicable, jamming measures keep developing and advancing. The traditional active jamming strategy relies on transmitting noise toward the radar to reduce its signal-to-noise ratio (SNR), diminishing the minimal range of detection at the expense of radio silence. Spoofing methods keep developing to supplement active jamming, with chaff decoys being the simplest example, designed to create false “ghost” targets on the screen of the investigating radar [21]-[26]. More advanced spoofing methods introduce repeaters that control the signatures on the reflected echoes, delaying them in time and imprinting false Doppler shifts which cause the radar to deduce the wrong trajectory and location of targets [27]-[30].

The inventors found that such methods are not capable of suppressing the reflection from the target itself, instead superimposing on it with an amplified spoofed echo from the repeater, thus attempting to cause the radar to track the more prominent reflection. It was not long for spoofing ECM to come under scrutiny from ECCM signal processing [31]-[33], severely challenging its effectiveness and continuing the apparently endless cycle of measures and countermeasures. Recently metamaterials and metasurfaces had been the focus of concentrated efforts to shape scattered waves [34]-[36], enabling novel pathways to passive stealth capabilities [37]-[39].

Today, time-dependent control over the properties of metamaterials is introducing a new degree of freedom to the problem of detection evasion and radar deception. By carefully controlling the temporal scattering properties, it was shown possible to imprint arbitrary signatures on the backscattered reflections [40]-[44]. These new designs promise to achieve similar performance to that of repeaters without suffering from their main drawback, the reliance on superimposed echoes.

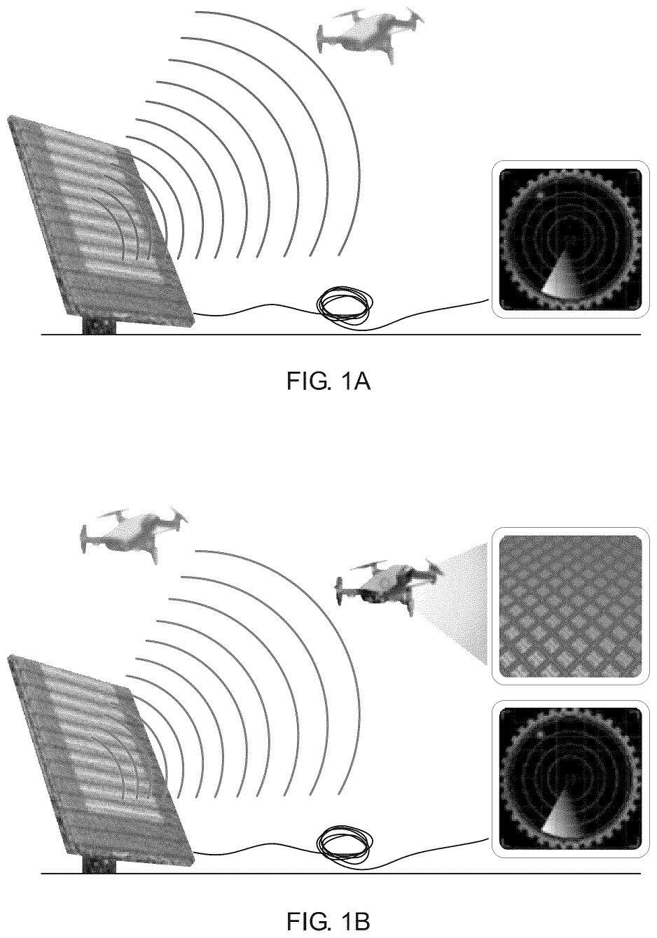

While conceiving the invention, the inventors realized that angular information can also be deceived. Most targets are essentially point-like scatterers generating a spherical-like outgoing wave. The wavefront at a large distance approaches a plane wave with respect to an investigating radar antenna array regardless of the geometric shape of the scattering body. To overcome this, an additional degree of freedom is optionally and preferably employed. This is achieved according to some embodiments of the present invention by time-dependent control over scattering properties of the reflecting target. This Example describes a method for the direction of arrival (DOA) deception with time-dependent targets. FIGS. 1A-B illustrate the scenario, where a target (a drone, in this example) is shown with and without a time-modulated cloak while being observed by the same radar system. The concealed drone in FIG. 1B modulates the backscattered echoes phase in such a way that it appears to arrive from an entirely different direction than it truly is.

### Theoretical Considerations

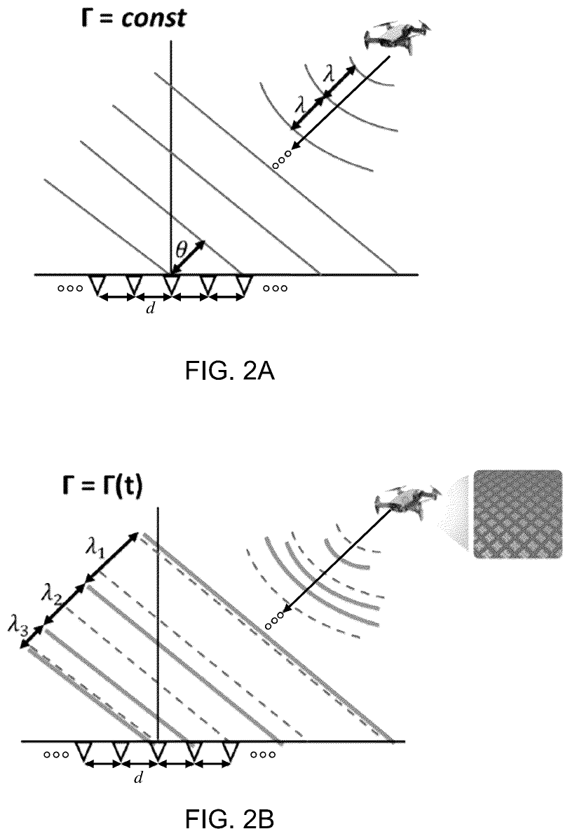

Consider a narrowband radar with a one-dimensional array of antennas separated by a distance d, as depicted in FIG. 2A. The array is considered to be uniform but non-uniform arrays behave similarly, and are therefore also contemplated in some embodiments of the present invention.

For standard scattering objects, such as exemplified by the drone, the backscattered wave reaches the array at the far field, with the wavefront well approximated by a plane wave. The peaks of the impinging wave are marked by the blue equal-phase lines, separated by a distance comparable to the wavelength λ. This scenario is akin to the intuitive analogue in water waves, where direction of arrival can be determined by the phase delay between the rising time of floating buoys. If all the buoys rise at the same time, the wave must be arriving from the front (θ=0), while any other delay between the rise times has a one-to-one relation to the DOA. The complex field phasor at the location of the nth (n=0, ±1, ±2 . . . ) antenna can be written as:

$${E}_{n} ∝ \vert Γ \vert {e}^{- j ( nkdSin ( θ ) + ∠Γ )} , \qquad ( EQ . 1 )$$

where ∠Γ is the phase of the reflection coefficient of the scatterer, |Γ| is its amplitude, k=2πλ=ωc is the free space wavenumber, ω the carrier frequency of the radar, c the speed of light, and j is an imaginary number satisfying j²=−1. The form of EQ. 1 suggests that detecting the direction of arrival is possible by Fourier transforming the vector of n samples and relating the largest output frequency to the DOA. While this is the straightforward approach, extensive research was conducted in the field of signal processing, allowing to sample non-uniformly and sparsely, surpassing the resolution and accuracy achievable by the naïve approach by employing algorithms such as multi-signal classification (MUSIC) and others [45], [46]. DOA estimation can be achieved with time-dependent metasurfaces that avoid the need for numerous receiving antennas and their associated costly radio frequency (RF) chains [47]-[51].

Irrespectively of the method of detection that is employed, EQ. 1 remains the basis for all, as there is a deterministic correlation between the phases in the different locations of the array-sampled space. To break this correlation, a time-modulated scatterer is employed according to some embodiments of the present invention. The time modulation is selected to switch its reflected phase sufficiently fast to decorrelate different receiving elements of the array, as shown on FIG. 2B. The dashed blue lines represent the wavefronts reflected from the regular scatterer as in FIG. 2A, while the orange lines represent the time dependent wavefronts, with the peaks no longer having equal distance between them. In such a scenario the form of EQ. 1 remains, substituting Γ→Γ(t).

It is appreciated that fast random switching of the reflected phase may potentially place the reflected waveform outside of the operational bandwidth of the radar system. While this can help concealing the target, the fast modulation may also cause the target to radiate by itself, making it visible to passive radar devices. Instead, a slower harmonic modulation is optionally and preferably performed to retain radio silence:

$$Γ ( t ) = {e}^{- j Ω t} , \qquad ( EQ . 2 )$$

where Ω can be positive or negative to reflect increasing or decreasing linear phase modulation respectively. Substituting EQ. 2 into EQ. 1 and considering the phase difference between adjacent antennas leads to:

$$Δϕ = ( 1 + \frac{Ω}{ω} ) kd Sin ( θ ) , \qquad ( EQ . 3 )$$

EQ. 3 reduces to the standard phase difference in classical linear antenna arrays when Ω=0, allowing to derive the relation between the real DOA Oreal and that which can be estimated by an unsuspecting algorithm:

$${θ}_{estimated} = {Sin}^{- 1} ( \frac{Δϕ}{kd} ) = {Sin}^{- 1} ( ( 1 + \frac{Ω}{ω} ) Sin ( {θ}_{real} ) ) . \qquad ( EQ . 4 )$$

EQ. 4 suggests that a controllable error which depends solely on the modulation frequency Ω of the reflecting time-modulated target can be introduced into the DOA estimation of the investigating radar. In this case the modulation is more pronounced. Performing a linear approximation of EQ. 4 results in a simple expression for the DOA error around small angles of incidence θᵣₑₐₗ:

$$Δθ = \vert {θ}_{estimated} - {θ}_{real} \vert \approx \frac{Ω}{ω} {θ}_{real} , \qquad ( EQ . 5 )$$

suggesting that exceeding an error a few degrees corresponds to modulation frequency of more than 5% of the carrier wave. Since 10% bandwidth around the carrier is common for radar systems, the method of the present embodiments can be employed in any practical radar.

The present embodiments successfully address also the effect of the deception on the Doppler velocity perceived by the radar. At first glance it might appear that the high frequency shift 12 caused by the harmonic modulation in EQ. 2 can be used to reveal that the proposed DOA deception method is being used, seeing as few objects could be expected to move fast enough in real scenarios to produce such high Doppler shifts. However, since the frequency shift of the carrier is still within the bandwidth of the radar, it is folded by the sampler into the Doppler domain defined by its pulse repetition frequency (PRF). By choosing the modulation frequency Ω as a (large) even integer of the PRF, the Doppler frequency can be made to vanish entirely, causing the target to appear static. By choosing some other modulation frequency the time modulated scatterer can be made to appear at arbitrary Doppler velocity. While using staggered pulses (alternating PRF sequences) may resolve some of the Doppler ambiguity, resolving the very large Doppler shift generated according to some embodiments of the present invention (above 5% from the carrier frequency) requires extreme alteration of the PRF, which is hard to implement in any practical radar system, making the DOA deception of the present embodiments suitable for integration with Doppler deception techniques [40]-[44].

The Doppler shift of the present embodiments also causes some of the radar waveform to remain outside of the radar's bandwidth, meaning that matched filters lose some SNR as well as add deformation to the output. The larger the frequency shift Ω is, the more distortion is inflicted on the matched output. However, since bandwidth is only a figure of merit that provides predetermined attenuation in that band, it does not completely filter out nearby frequencies. Therefore, even a large shift by an amount of, for example, half the bandwidth (Ω=B/2) would still be detectable. According to some embodiments of the present invention the DOA error achieved by the method of the present embodiments is less than Δθₘₐₓ, where Δθₘₐₓ is approximated by:

$${Δθ}_{max} \approx \frac{B}{2 ω} {θ}_{real} . \qquad ( EQ . 6 )$$

Other (e.g., higher) values for Δθₘₐₓ are also contemplated.

### EXPERIMENTAL

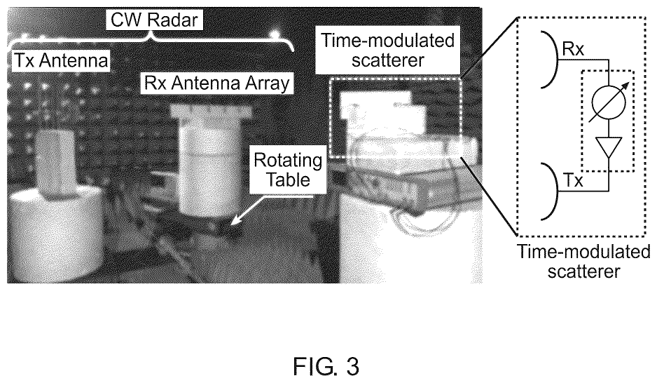

To validate the theoretical results described above, an experiment was conducted in the anechoic chamber as shown in FIG. 3.

A continuous wave (CW) radar was assembled with the carrier frequency of 820 MHz, consisting of a transmitting UHF log-periodic antenna (CLP5130-2) directed at the time-modulated scatterer, as well as a 4-element uniformly spaced antenna array (d=λ/2=183 mm) that recorded the reflected echoes. Signals on the two central antennas were directly sampled by a scope (Keysight DSOX3104T) while the peripheral two antennas located on the sides of the array were loaded with 50 Ohm terminations for better matching of the receivers. The time-modulated scatterer shown in FIG. 3 was constructed from a pair of identical antennas, one receiving and the other transmitting, with a phase shifter placed in between as seen in the inset of FIG. 3. The phase shifter was controlled by an RF vector modulator (AD8340), capable of arbitrary dynamic phase control over more than 60 MHz bandwidth, which was followed by an amplifying stage to compensate for losses. The control over the phase of the RF vector modulator was performed with an arbitrary function generator (Keysight 81160A) which was configured to create harmonic modulation in the phase Γ(t) as in EQ. 2. The receiving array was placed on a rotating table, allowing to control the true DOA of the target. A configuration in which the amplifying unit is not employed is also contemplated. In this Example its replica was used to reduce the design complexity and also to avoid a need to send high-power signals.

The experimental setup was first calibrated by recording the phases at the receivers for a forward-facing scatterer (θᵣₑₐₗ=0) with its modulation frequency set to 0 Hz (no modulation). In this case, the phase difference between the receivers is expected to be zero for perfectly calibrated instrumentation, however, the various lengths of connecting cables and other equipment in the receiver can cause a phase shift between the channels. Calibration is therefore simply performed by subtracting these measured values from all subsequent measurements at each antenna (φ→φ−φ_{calib}).

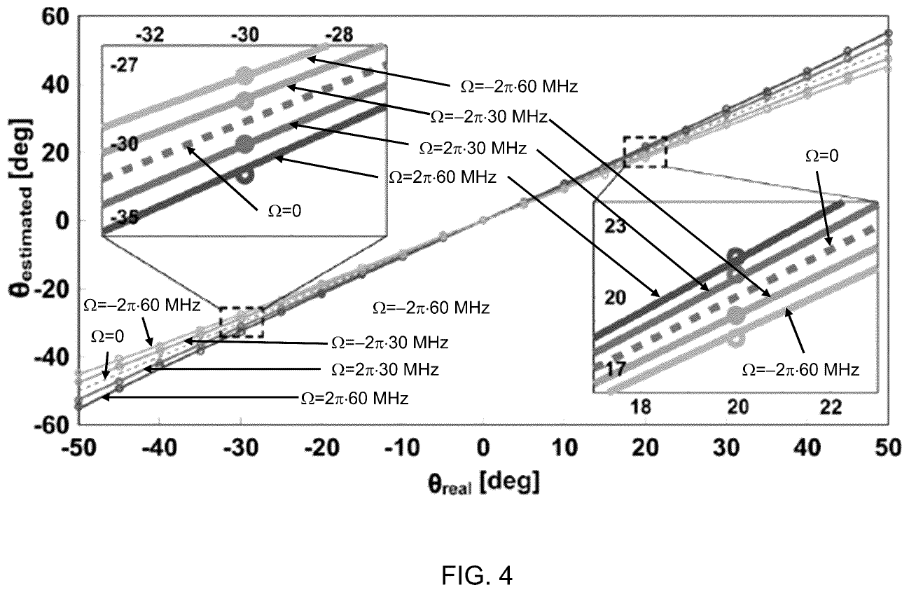

The experiment was conducted by rotating the receiving array by 10-degree steps from −50 to 50 degrees, estimating the DOA using the calibration and EQ. 4 (substituting Ω=0, which corresponds to an unsuspecting radar system anticipating echoes to not be significantly shifted in frequency). The experiment was repeated by performing positive and negative modulations of 30 and 60 MHz, where the sign corresponds to increasing or decreasing phase modulation according to EQ. 2. The results are shown in FIG. 4, demonstrating excellent agreement between the theoretical prediction (EQ. 4) and experiment, and achieving more than 5 degrees of DOA at the edges of the sampled parameters (Ω=±60 MHz, θᵣₑₐₗ=±50 [deg]). A linear relationship is observed between the real and estimated DOA, with the slope proportional to the modulation frequency, demonstrating steerability of the perceived DOA by modulation of the time dependent scatterer.

The direction of arrival deception method presented in this Example employed dynamic control over the scattering properties of the time-dependent target. Upwards of 5 degrees of steerable angular error were demonstrated for a radar system possessing a standard bandwidth of about 10% around its central carrier frequency.

In some embodiments of the present invention the scattered field in the direction of the investigating radar is added coherently from all the various scattering centers. This is particularly useful for large objects, e.g., from about 10 meters to about 100 meters in their largest dimension.

It was found by the Inventor that the more broadband a radar is, the more susceptible it will be to such deception, as shown in EQ. 6. In some embodiments of the present invention the method does not require knowledge of the direction of the interrogating radar to counteract it. The errors that is introduced by the deception depends on the angular position of the radar, as described by EQ. 5.

In some cases the PRF of the radar is frequently staggered (alternate) in order to remove Doppler and range ambiguities. Staggered pulses reflected off the time-dependent scatterer of the present embodiments may result in alternating Doppler frequencies associated with the target. This however, is typically resolved by the radar simply as the closest reasonable velocity above the Nyquist velocity. While this can still make the target appear somewhat fast to the radar, this can serve to further confuse its tracker, which will struggle to make sense of the discrepancy between the large expected velocity and the much slower actual range rate of the target.

The method of the present embodiments can be implemented alongside with other deception methods, such as, but not limited to, the method described in international patent application, publication No. WO2021/210004, the contents of which are hereby incorporated by reference. This allows presenting the radar with false range, velocity, and direction, accounting for the entirety of the available degrees of freedom of the radar.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

### REFERENCES

[1] R. Klemm, H. Griffiths, and W. Koch, Novel Radar Techniques and Applications, vol. 2. 2017.
[2] M. Mahfouz, A. Fathy, Y. Yang, E. E. H. Ali, and A. Badawi, “See-through-wall imaging using ultra wideband pulse systems,” Proceedings—34th Applied Image Pattern Recognition Workshop, AIPR 2005, pp. 48-53, 2005, doi: 10.1109/AIPR.2005.40.
[3] J. S. Lee, C. Nguyen, and T. Scullion, “A novel, compact, low-cost, impulse ground-penetrating radar for nondestructive evaluation of pavements,” IEEE Trans Instrum Meas, vol. 53, no. 6, pp. 1502-1509, 2004, doi: 10.1109/TIM.2004.827308.
[4] M. Murad, J. Nickolaou, G. Raz, J. S. Colburn, and K. Geary, “Next Generation Short Range Radar (SRR) for Automotive Applications,” in proc. IEEE Radar, 2012, pp. 214-219.
[5] P. Van Dorp and F. C. A. Groen, “Human walking estimation with radar,” in IEE. Proc. Radar Sonar and Navigation, 2003, vol. 150, no. 5. doi: 10.1049/ip-rsn.
[6] C. Gu, C. Li, J. Lin, J. Long, J. Huangfu, and L. Ran, “Instrument-based noncontact doppler radar vital sign detection system using heterodyne digital quadrature demodulation architecture,” IEEE Trans Instrum Meas, vol. 59, no. 6, pp. 1580-1588, 2010, doi: 10.1109/TIM.2009.2028208.
[7] V. Kozlov, D. Vovchuk, S. Kosulnikov, D. Filonov, and P. Ginzburg, “Micro-Doppler signatures of subwavelength nonrigid bodies in motion,” Phys Rev B, vol. 104, no. 5, pp. 1-6, 2021, doi: 10.1103/PhysRevB.104.054307.
[8] R. Komissarov, V. Kozlov, D. Filonov, and P. Ginzburg, “Partially coherent radar unties range resolution from bandwidth limitations,” Nat Commun, vol. 10, no. 1423, pp. 1-9, 2019, doi: 10.1038/s41467-019-09380-x.
[9] D. Kissinger, Millimeter-Wave Receiver Concepts for 77 GHz Automotive Radar in Scilicon-Germanium Technology. 2012. doi: 10.1007/978-1-4614-2290-7.
[10] R. Zetik, J. Sachs, and R. Thoma, “UWB short-range radar sensing—The architecture of a baseband, pseudo-noise UWB radar sensor,” IEEE Instrum Meas Mag, vol. 10, no. 2, pp. 39-45, 2007.
[11] S. Feng, N. Mughees, and V. Wollesen, “Reviewing the Application and Integration of Software Defined Radios to Radar Systems,” IEEE National Radar Conference—Proceedings, vol. 2020-September, 2020, doi: 10.1109/RadarConf2043947.2020.9266396.
[12] H. Zhang, L. Li, and K. Wu, “24 GHz Software-Defined Radar System for Automotive Applications,” in 10th European Conference on Wireless Technology, 2007, no. October, pp. 138-141.
[13] P. M. Grant and J. H. Collins, “Introduction to electronic warfare,” IEE Proceedings F: Communications Radar and Signal Processing, vol. 129, no. 3, pp. 113-132, 1982, doi: 10.1049/ip-f-1.1982.0020.
[14] L. Neng-Jing and Z. Yi-Ting, “A Survey of Radar ECM and ECCM,” vol. 31, no. 3, 1995.
[15] F. A. Butt, I. H. Naqvi, and A. I. Najam, “Radar ECCM against deception jamming: A novel approach using bi-static and mono-static radars,” 2012 15th International Multitopic Conference, INMIC 2012, pp. 137-141, 2012, doi: 10.1109/INMIC.2012.6511482.
[16] D. J. Bachmann, R. J. Evans, and B. Moran, “Game theoretic analysis of adaptive radar jamming,” IEEE Trans Aerosp Electron Syst, vol. 47, no. 2, pp. 1081-1100, 2011, doi: 10.1109/TAES.2011.5751244.
[17] G. Frazer, A. Balleri, and G. Jacob, “Deception Jamming against Doppler Beam Sharpening Radars,” IEEE Access, vol. 8, pp. 32792-32801, 2020, doi: 10.1109/ACCESS.2020.2973191.
[18] R. Chauhan, “A Platform for False Data Injection in Frequency Modulated Continuous Wave Radar,” All Graduate Theses and Dissertations, 2014.
[19] G. A. Rao and S. P. Mahulikar, “Integrated review of stealth technology and its role in airpower,” The Aeronautical Journal, vol. 106, no. 1066, pp. 629-642, 2002, doi: 10.1017/s0001924000011702.
[20] W. F. Bahret, “The Beginnings of Stealth Technology,” IEEE Trans Aerosp Electron Syst, vol. 29, no. 4, pp. 1377-1385, 1970.
[21] C. Chi-Hao and J. Tsui, An Introduction to Electronic Warfare; from the First Jamming to Machine Learning Techniques.
[22] S. Kosulnikov et al., “Circular wire-bundle superscatterer,” J Quant Spectrosc Radiat Transf, vol. 279, p. 108065, March 2022, doi: 10.1016/J.JQSRT.2022.108065.
[23] D. Dobrykh et al., “Multipole engineering for enhanced backscattering modulation,” Phys Rev B, vol. 102, no. 19, p. 195129, November 2020, doi: 10.1103/PHYSREVB.102.195129/FIGURES/5/MEDIUM.
[24] D. Filonov, A. Shmidt, A. Boag, and P. Ginzburg, “Artificial localized magnon resonances in subwavelength meta-particles,” Appl Phys Lett, vol. 113, no. 12, p. 123505, September 2018, doi: 10.1063/1.5047445.
[25] K. Grotov et al., “Genetically Designed Wire Bundle Super-Scatterers,” IEEE Trans Antennas Propag, pp. 1-1, 2022, doi: 10.1109/TAP.2022.3177531.
[26] A. Mikhailovskaya et al., “Superradiant Scattering Limit for Arrays of Subwavelength Phys Rev Appl, vol. 18, no. 5, p. 054063, November 2022, doi: 10.1103/PhysRevApplied.18.054063.
[27] R. Komissarov and A. Wool, “Spoofing Attacks Against Vehicular FMCW Radar,” pp. 91-97, 2021, doi: 10.1145/3474376.3487283.
[28] A. Lazaro, A. Porcel, M. Lazaro, R. Villarino, and D. Girbau, “Spoofing Attacks on FMCW Radars with Low-Cost Backscatter Tags,” Sensors, vol. 22, no. 6, 2022, doi: 10.3390/s22062145.
[29] D. Feng, L. Xu, X. Pan, and X. Wang, “Jamming Wideband Radar Using Interrupted-Sampling Repeater,” IEEE Trans Aerosp Electron Syst, vol. 53, no. 3, pp. 1341-1354, 2017, doi: 10.1109/TAES.2017.2670958.
[30] D. H. A. Maithripala and S. Jayasuriya, “Radar deception through phantom track generation,” Proceedings of the American Control Conference, vol. 6, pp. 4102-4106, 2005, doi: 10.1109/acc.2005.1470620.
[31] J. Zhang, D. Zhu, and G. Zhang, “New antivelocity deception jamming technique using pulses with adaptive initial phases,” IEEE Trans Aerosp Electron Syst, vol. 49, no. 2, pp. 1290-1300, 2013, doi: 10.1109/TAES.2013.6494414.
[32] Z. Liu, J. Sui, Z. Wei, and X. Li, “A sparse-driven anti-velocity deception jamming strategy based on pulse-doppler radar with random pulse initial phases,” Sensors (Switzerland), vol. 18, no. 4, pp. 1-17, 2018, doi: 10.3390/s18041249.
[33] C. Zhou, Z. B. Zhu, and Z. Y. Tang, “A Novel Waveform Design Method for Shift-Frequency Jamming Confirmation,” Int J Antennas Propag, vol. 2018, no. 2, 2018, doi: 10.1155/2018/1569590.
[34] F. Capolino, Applications of Metamaterials. 2017. doi: 10.1201/9781420054248.
[35] N. Engheta and R. W. Ziolkowski, Metamaterials—Physics and Engineering Explorations. 2006.
[36] D. R. Smith, J. B. Pendry, and M. C. K. Wiltshire, “Metamaterials and Negative Refractive Index,” Science (1979), vol. 305, no. August, pp. 788-792, 2004.
[37] D. Schurig et al., “Metamaterial electromagnetic cloak at microwave frequencies.,” Science, vol. 314, no. 5801, pp. 977-980, November 2006, doi: 10.1126/science.1133628.
[38] P. Alitalo and S. Tretyakov, “Electromagnetic cloaking with metamaterials,” Materials Today, vol. 12, no. 3, pp. 22-29, 2009, doi: 10.1016/S1369-7021 (09) 70072-0.
[39] R. Fleury and A. Alu, “Cloaking and Invisibility: A Review,” Progress In Electromagnetics Research, vol. 147, no. February, pp. 171-202, 2014.
[40] V. Kozlov, D. Vovchuk, and P. Ginzburg, “Broadband radar invisibility with time-dependent metasurfaces,” Sci Rep, vol. 11, no. 1, pp. 1-11, 2021, doi: 10.1038/s41598-021-93600-2.
[41] X. G. Zhang et al., “Smart Doppler Cloak Operating in Broad Band and Full Polarizations,” Advanced Materials, vol. 2007966, pp. 1-8, 2021, doi: 10.1002/adma.202007966.
[42] B. Liu, Y. He, S.-W. Wong, and Y. Li, “Experimental demonstration of a time-domain digital-coding metasurface for a Doppler cloak,” Opt Express, vol. 29, no. 2, p. 740, 2021, doi: 10.1364/oe.414408.
[43] B. Liu, H. Giddens, Y. Li, Y. He, S.-W. Wong, and Y. Hao, “Design and experimental demonstration of Doppler cloak from spatiotemporally modulated metamaterials based on rotational Doppler effect,” Opt Express, vol. 28, no. 3, p. 3745, 2020, doi: 10.1364/oe.382700.
[44] D. Ramaccia, D. L. Sounas, A. Alu, A. Toscano, and F. Bilotti, “Phase-Induced Frequency Conversion and Doppler Effect with Time-Modulated Metasurfaces,” IEEE Trans Antennas Propag, vol. 68, no. 3, pp. 1607-1617, 2020, doi: 10.1109/TAP.2019.2952469.
[45] E. Tuncer and B. Friedlander, Classical and Modern Direction-of-Arrival Estimation. Elsevier, 2009.
[46] H. L. Van Trees, Optimum Array Processing. 2002.
[47] X. Wang and C. Caloz, “Direction-of-Arrival (DOA) Estimation based on Spacetime-Modulated Metasurface,” IEEE, no. 1, pp. 1613-1614, 2019.
[48] X. Fang et al., “Accurate Direction-of-Arrival Estimation Method based on Space-Time Modulated Metasurface,” IEEE Trans Antennas Propag, 2022, doi: 10.1109/TAP.2022.3184556.
[49] Q. Y. Zhu, J. W. Wu, and S. R. Weng, “Two-dimensional direction-of-arrival estimation based on time-domain-coding digital metasurface,” APL, vol. 181702, no. October 2022, doi: 10.1063/5.0124291.
[50] T. V. Hoang, V. Fusco, M. A. B. Abbasi, and O. Yurduseven, “Single-pixel polarimetric direction of arrival estimation using programmable coding metasurface aperture,” Sci Rep, vol. 11, no. 1, pp. 1-17, 2021, doi: 10.1038/s41598-021-03228-5.
[51] D. Vovchuk, M. Khobzei, D. Filonov, and P. Ginzburg, “Naked eye direction of arrival estimation with a Fresnel lens,” Sci Rep, vol. 12, no. 1, pp. 3-12, 2022, doi: 10.1038/s41598-022-06480-5.

1. A system for angular deception, comprising:
a structure having a plurality of resonators characterized by a controllable phase shift between an electromagnetic wave incident on said structure and an electromagnetic wave scattered off said structure; and
a controller configured for modulating said phase shift at a modulation frequency of at least 0.01 of a bandwidth of said incident electromagnetic wave.

2. The system according to claim 1, wherein said structure comprises a receiving element receiving said incident electromagnetic wave, a transmitting element transmitting said scattered electromagnetic wave, and phase delay circuit between said receiving and said transmitting elements.

3. The system according to claim 2, wherein said phase delay circuit is configured to ensure a time-dependent phase delay between said incident electromagnetic wave and said scattered electromagnetic wave.

4. The system according to claim 2, wherein at least one of said phase delay circuits comprises an electronic element having a controllable impedance, wherein said controlling said phase shift comprises varying said impedance.

5. The system according to claim 4, wherein said electronic element has a voltage-dependent impedance, and wherein said varying said impedance comprises varying a bias voltage applied to said electronic element.

6. The system according to claim 1, further comprising a metal screen and dielectric structure, between said resonators and said metal screen, wherein said resonators are mounted on said dielectric structure.

7. (canceled)

8. The system according to claim 1, wherein said modulation comprises harmonic modulation.

9. (canceled)

10. The system according to claim 1, wherein said modulation frequency is from about 10 MHz to about 50 GHz.

11. (canceled)

12. The system according to claim 1, wherein at least a portion of said resonators are also characterized by a controllable resonance frequency, and wherein said controller is configured for controlling said resonance frequency to provide a time-varying resonance frequency characterized by a temporal function which comprises a linear time-dependence.

13. (canceled)

14. The system according to claim 12, wherein said controller is configured to receive velocity data characterizing a motion of a vehicle and to select said time-varying resonance frequency based on said velocity data.

15. (canceled)

16. The system according to claim 12, wherein said phase shift is over a respective range of at least 1.5π.

17. The system according to claim 12, being configured for a central frequency of said incident wave, wherein at least one of said resonators has a dispersive response to said incident wave, said dispersive response being selected to ensure that said phase shift range is effective for any frequency within a frequency band of at least 10% of said central frequency.

18. The system according to claim 14, being configured for a central frequency of said incident wave, wherein at least one of said resonators has a dispersive response to said incident wave, said dispersive response being selected to ensure that said phase shift range is effective for any frequency within a frequency band of at least 10% of said central frequency.

19. The system according to claim 17, wherein said dispersive response comprises a frequency-dependent impedance.

20. The system according to claim 18, wherein said dispersive response comprises a frequency-dependent impedance.

21. The system according to claim 12, wherein at least one of said resonators is configured to maintain, within a predetermined tolerance, equality between a frequency of said scattered wave and a frequency of said incident wave.

22. The system according to claim 12, wherein at least one of said resonators comprises an electronic element having a controllable impedance, wherein said controlling said resonance frequency comprises varying said impedance.

23. A vehicle, comprising:
a propulsion system carried by a vehicle body; and
the system according to claim 1, mounted on an external surface of said vehicle body.

24. The vehicle according to claim 23, being a manned vehicle.

25. The vehicle according to claim 23, being an unmanned vehicle.

26. The vehicle according to claim 23, being a controllable vehicle.

27. The vehicle according to claim 23, being an autonomous vehicle.

28. A method of angular deception of a detection system transmitting an electromagnetic wave, the method comprising:
scattering the detection system's wave off a structure having a plurality of resonators characterized by a controllable phase shift between an electromagnetic wave incident on said structure and an electromagnetic wave scattered off said structure; and
modulating said phase shift at a modulation frequency of at least 0.01 of a bandwidth of said incident electromagnetic wave.
